(19) United States
(12) Patent Application Publication
(10) Pub. No.: US 2016/0072194 A1
(43) Pub. Date: Mar. 10, 2016

(54) MIMO ANTENNA DEVICE

(71) Applicant: NEC CORPORATION, Tokyo (JP)

(72) Inventors: Takahide YOSHIDA, Tokyo (JP); Hiroshi TOYAO, Tokyo (JP)

(73) Assignee: NEC CORPORATION, Tokyo (JP)

(21) Appl. No.: 14/888,234

(22) PCT Filed: May 23, 2014
(86) PCT No.: PCT/JP2014/002722

§ 371 Date: Oct. 30, 2015

(30) Foreign Application Priority Data
May 28, 2013 (JP) 2013-111867

(51) Int. Cl. H01Q 21/00

(52) U.S. Cl. CPC H01Q 21/0075

(57) ABSTRACT

The MIMO antenna device of the present invention includes a first conductor layer having a first opening portion, a first feed line and a second feed line. Each of the first feed line and the second feed line crosses the first opening portion, has a connection point with a first opening edge of the first opening portion, and feeds power to the first conductor layer at the connection point, wherein the first conductor layer includes a first split portion and a second split portion at the first opening edge. The first split portion and the second split portion are cut up to a conductor edge of the first conductor layer. Thus, the MIMO antenna device which is small in size and securing isolation between antenna ports is realized.

### TECHNICAL FIELD

The present invention relates to a MIMO antenna device which can be formed in small size.

### BACKGROUND ART

Recently, Multiple-Input Multiple-Output (hereinafter, abbreviated as MIMO) systems have become popular in wireless communication. A MIMO system is a space division multiplexing (SDM) transmission system. Multiple antennas on the transmitting side transmit information streams different from each other and multiple antennas on the receiving side receive them. Therefore, the MIMO system can greatly increase a channel capacity in comparison with conventional wireless communication.

A wireless communication device used for the MIMO system includes multiple antenna elements having the same resonant frequency. A mutual coupling occurs between antenna ports of the multiple antenna elements. However, there is a problem that the mutual coupling between antenna ports cause degrades communication characteristics. As a means to solve this problem, there is MIMO SYSTEM disclosed in FIG. 3 of PTL 1. In PTL 1, a mutual coupling which occurs between antenna ports of a MIMO antenna is eliminated by bridging between two monopole antennas with a metal wire.

### CITATION LIST

### Patent Literature

[PTL 1] US Patent Application Publication No. 2011/0267245

### SUMMARY OF INVENTION

### Technical Problem

However, in MIMO ANTENNA SYSTEM disclosed in PTL 1, it is certainly necessary that two monopole antennas are spaced apart with a certain interval via a metal wire. Accordingly, in MIMO ANTENNA SYSTEM disclosed in PTL 1, miniaturization of an entire antenna is a problem.

The present invention is made in view of the above problem. An object of the present invention is to provide a MIMO antenna device which is small in size and capable of securing isolation between antenna ports.

### Solution to Problem

A MIMO antenna device according to the present invention includes a first conductor layer having a first opening portion and a first feed line and a second feed line. Each of the first feed line and the second feed line crosses the first opening portion, has a connection point with a first opening edge of the first opening portion, and feeds power to the first conductor layer at the connection points. The first conductor layer includes a first split portion and a second split portion at the first opening edge. The first split portion and a second split portion are cut up to a conductor edge of the first conductor layer.

### Advantageous Effects of Invention

According to the present invention, a MIMO antenna device which is small in size and securing isolation between antenna ports can be provided.

### BRIEF DESCRIPTION OF DRAWINGS

FIG. 1 is a perspective view illustrating a structure of a MIMO antenna device of a second exemplary embodiment of the present invention.

FIG. 2 is an exploded view illustrating the structure of the MIMO antenna device of the second exemplary embodiment of the present invention.

FIG. 3 is a perspective view illustrating a structure of a dual-split ring of the MIMO antenna device of the second exemplary embodiment of the present invention.

FIG. 4 is a graph representing frequency characteristics of S parameters of the MIMO antenna device of the second exemplary embodiment of the present invention.

FIG. 5 is a graph representing a frequency characteristic of an emission efficiency of the MIMO antenna device of the second exemplary embodiment of the present invention.

FIG. 6 is a graph representing a frequency characteristic of a correlation coefficient of the MIMO antenna device of the second exemplary embodiment of the present invention.

FIG. 7 is a perspective view illustrating a structure of a MIMO antenna device of a third exemplary embodiment of the present invention.

FIG. 8 is an exploded view illustrating the structure of the MIMO antenna device of the third exemplary embodiment of the present invention.

FIG. 9 is a perspective view illustrating a structure of a MIMO antenna device of a fourth exemplary embodiment of the present invention.

FIG. 10 is a perspective view illustrating a structure of a MIMO antenna device of a fifth exemplary embodiment of the present invention.

FIG. 11 is a perspective view illustrating a structure of a MIMO antenna device of a sixth exemplary embodiment of the present invention.

FIG. 12 is a perspective view illustrating a modified example of the structure of the MIMO antenna device of the sixth exemplary embodiment of the present invention.

FIG. 13 is a perspective view illustrating a structure of a MIMO antenna device of a seventh exemplary embodiment of the present invention.

FIG. 14 is an exploded view illustrating the structure of the MIMO antenna device of the seventh exemplary embodiment of the present invention.

FIG. 15 is a perspective view illustrating a structure of a dual-split ring of the MIMO antenna device of the seventh exemplary embodiment of the present invention.

FIG. 16 is a perspective view illustrating a structure of a dual-split ring of a MIMO antenna device of an eighth exemplary embodiment of the present invention.

FIG. 17 is a perspective view illustrating a structure of a modified example of the dual-split ring of the MIMO antenna device of the eighth exemplary embodiment of the present invention.

FIG. 18 is a perspective view illustrating a structure of a modified example of the dual-split ring of the MIMO antenna device of the eighth exemplary embodiment of the present invention.

FIG. 19 is a perspective view illustrating a structure of a modified example of the dual-split ring of the MIMO antenna device of the eighth exemplary embodiment of the present invention.

FIG. 20 is a perspective view illustrating a structure of a dual-split ring of the MIMO antenna device, in which six conductor layers are used, of the second exemplary embodiment of the present invention.

FIG. 21 is a top view illustrating a structure of a MIMO antenna device of a first exemplary embodiment of the present invention.

### DESCRIPTION OF EMBODIMENTS

Hereinafter, with reference to the drawings, exemplary embodiments of the present invention will be explained in detail. Technically preferred limitations are imposed on exemplary embodiments described below in order to implement the present invention. However the scope of the invention is not limited to following exemplary embodiments.

### First Exemplary Embodiment

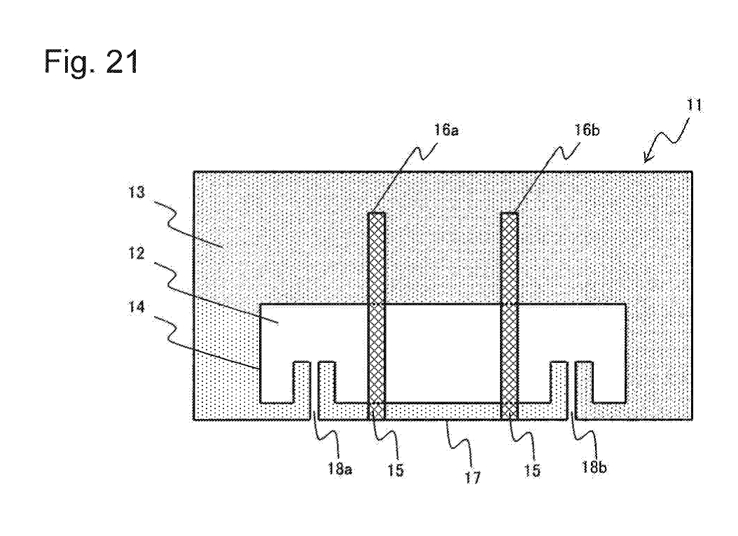

FIG. 21 is a top view illustrating a structure of a MIMO antenna device 11 of a first exemplary embodiment of the present invention. The MIMO antenna device 11 of the present exemplary embodiment includes a first conductor layer 13 having a first opening portion 12. The MIMO antenna device 11 further includes a first feed line 16a and a second feed line 16b across the first opening portion 12. The first feed line 16a and the second feed line 16b include connection points 15 with a first opening edge 14 of the first opening portion 12. Power is fed to the first conductor layer 13 from the first feed line 16a and the second feed line 16b at the connection points 15. The first conductor layer 13 includes a first split portion 18a and a second split portion 18b which are cut from the first opening edge 14 up to a conductor edge 17 of the first conductor layer 13.

According to the present exemplary embodiment, the MIMO antenna device 11 which is small in size and securing isolation between antenna ports is realized.

### Second Exemplary Embodiment

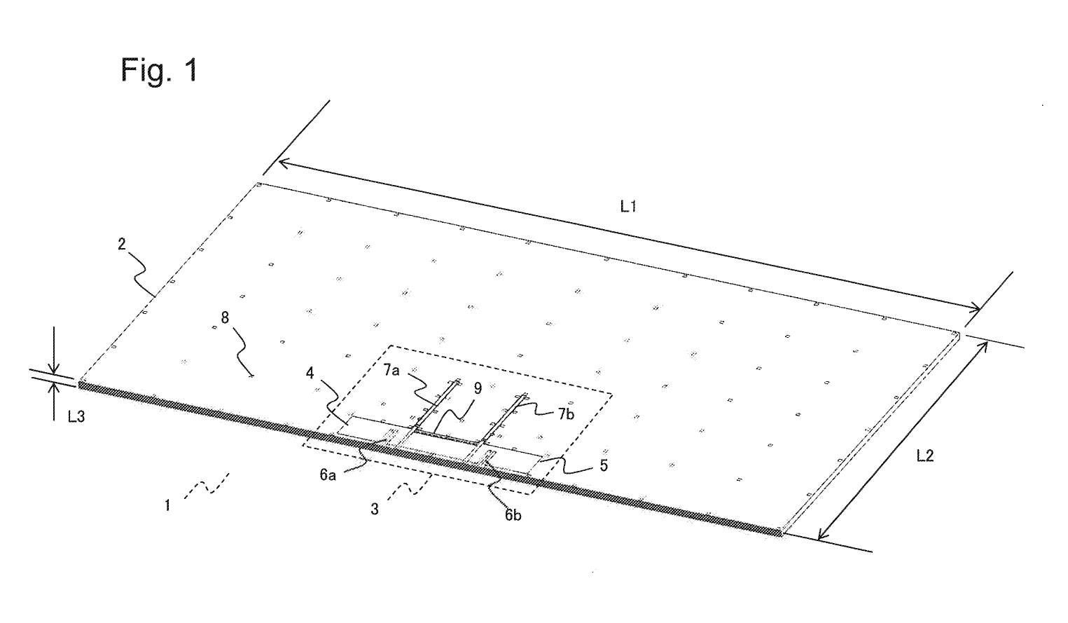

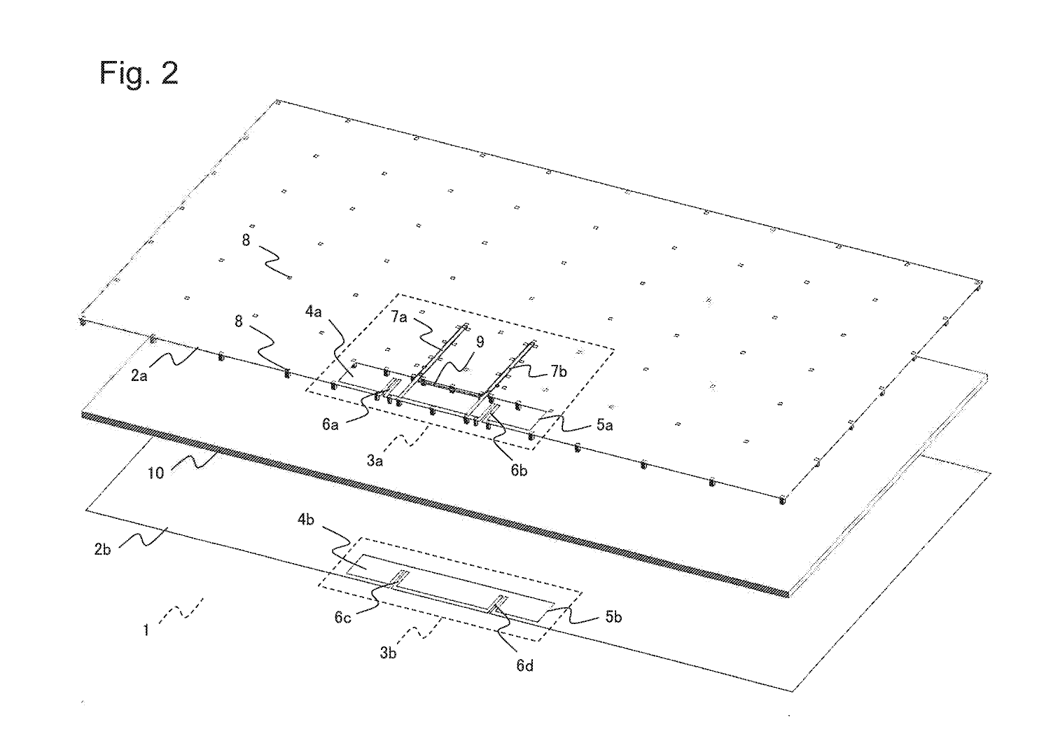

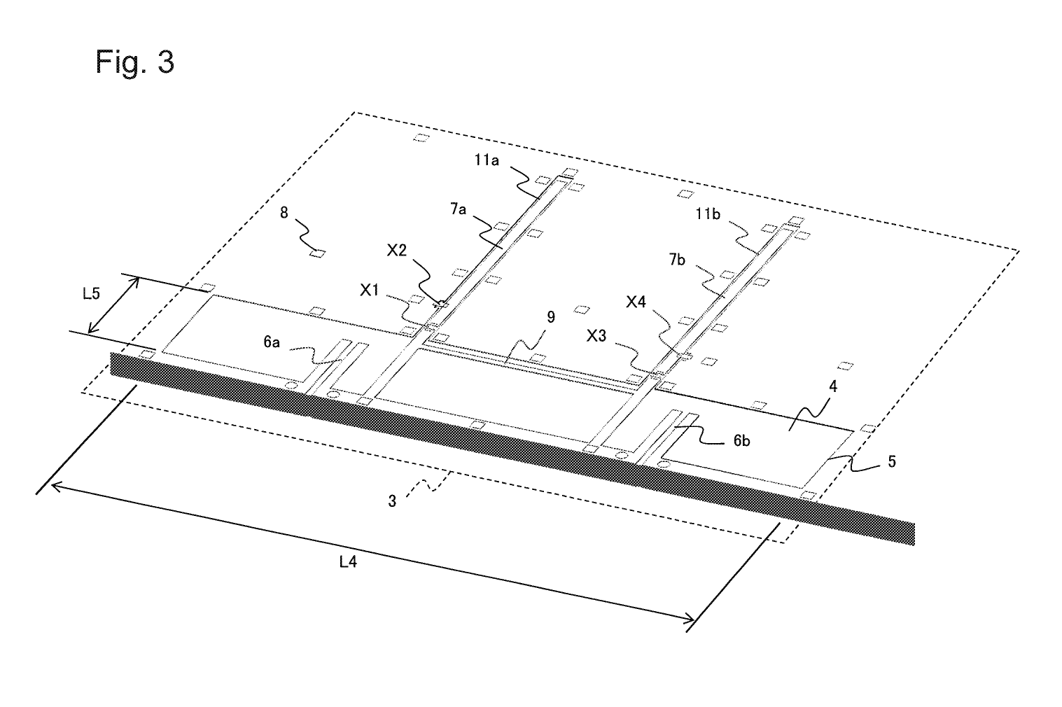

FIG. 1, FIG. 2, and FIG. 3 are perspective or exploded views illustrating a structure of a MIMO antenna device 1 of a second exemplary embodiment of the present invention. FIG. 1 is a perspective view illustrating the structure of the MIMO antenna device 1 of the second exemplary embodiment. FIG. 2 is an exploded view illustrating the structure of the MIMO antenna device 1. FIG. 3 is a perspective view illustrating by enlarging a structure of a dual-split ring 3 of the MIMO antenna device 1.

The MIMO antenna device 1 of the second exemplary embodiment includes a conductor layer 2 having a first conductor layer 2a and a second conductor layer 2b on the front side and the back side of a dielectric layer 10. The MIMO antenna device 1 includes a plurality of metal vias 8 for electrically connecting the first conductor layer 2a and the second conductor layer 2b through the dielectric layer 10. The first conductor layer 2a includes a first dual-split ring 3a. The first dual-split ring 3a includes a first opening portion 4a. Similarly, the second conductor layer 2b includes a second dual-split ring 3b. The second dual-split ring 3b includes a second opening portion 4b. A first opening edge 5a of the first opening portion 4a includes a first split portion 6a and a second split portion 6b which are cut up to a conductor edge which is an outer periphery of the first conductor layer 2a. Similarly, a second opening edge 5b of the second opening portion 4b includes a third split portion 6c and a fourth split portion 6d which are cut up to a conductor edge which is an outer periphery of the second conductor layer 2b.

Furthermore, in the front side of the first conductor layer 2a, a first feed line 7a and a second feed line 7b are arranged across the first opening portion 4a. An end of each of the first feed line 7a and the second feed line 7b is respectively connected to the first opening edge 5a. A first clearance 11a and a second clearance 11b are formed from the first opening portion 4a toward the inside of the first conductor layer 2a. The first feed line 7a is arranged along the first clearance 11a. The second feed line 7b is arranged along the second clearance 11b. Power is fed to the first conductor layer 2a and the second conductor layer 2b from the first feed line 7a and the second feed line 7b.

Inside the first opening portion 4a of the first dual-split ring 3a, a bridge line 9 which bridges between the first feed line 7a and the second feed line 7b is arranged. When the first feed line 7a or the second feed line 7b feeds power, the bridge line 9 suppresses a current from being mixed into the other feed line. In other words, the MIMO antenna device 1 of the present exemplary embodiment can secure isolation between antenna ports by the bridge line 9. Note that the bridge line 9 is linear in the present exemplary embodiment but obviously its structure is not limited to this. For example, the bridge line 9 may be a meandering shape.

L-shaped matching circuits which are formed using lumped constants X1 to X4 are connected to the first feed line 7a and the second feed line 7b. The L-shaped matching circuits are matching with an input impedance of the dual-split ring 3 viewed from each of the first feed line 7a and the second feed line 7b.

A resonant frequency of an antenna is determined by a capacitance and an inductance. A capacitance of the MIMO antenna device 1 arises from the first split portion 6a and the second split portion 6b and from the third split portion 6c and the fourth split portion 6d. An inductance of the MIMO antenna device 1 arises from path lengths of the first opening edge 5a and the second opening edge 5b. The resonant frequency becomes lower as the capacitance and/or the inductance becomes larger. For example, when lengths of the first split portion 6a and the second split portion 6b and the third split portion 6c and the fourth split portion 6d are increased, the capacitance of the MIMO antenna device 1 becomes large. In other words, since the resonant frequency of the MIMO antenna device 1 becomes low, the MIMO antenna device 1 is miniaturized without changing an occupied area of the entire antenna.

Furthermore, the dual-split ring 3 plays a role of two antennas by itself. The dual-split ring 3 does not need to space the two antennas apart with a certain interval unlike the MIMO antenna of PTL 1. Accordingly, the dual-split ring 3 facilitates miniaturization of the MIMO antenna device 1.

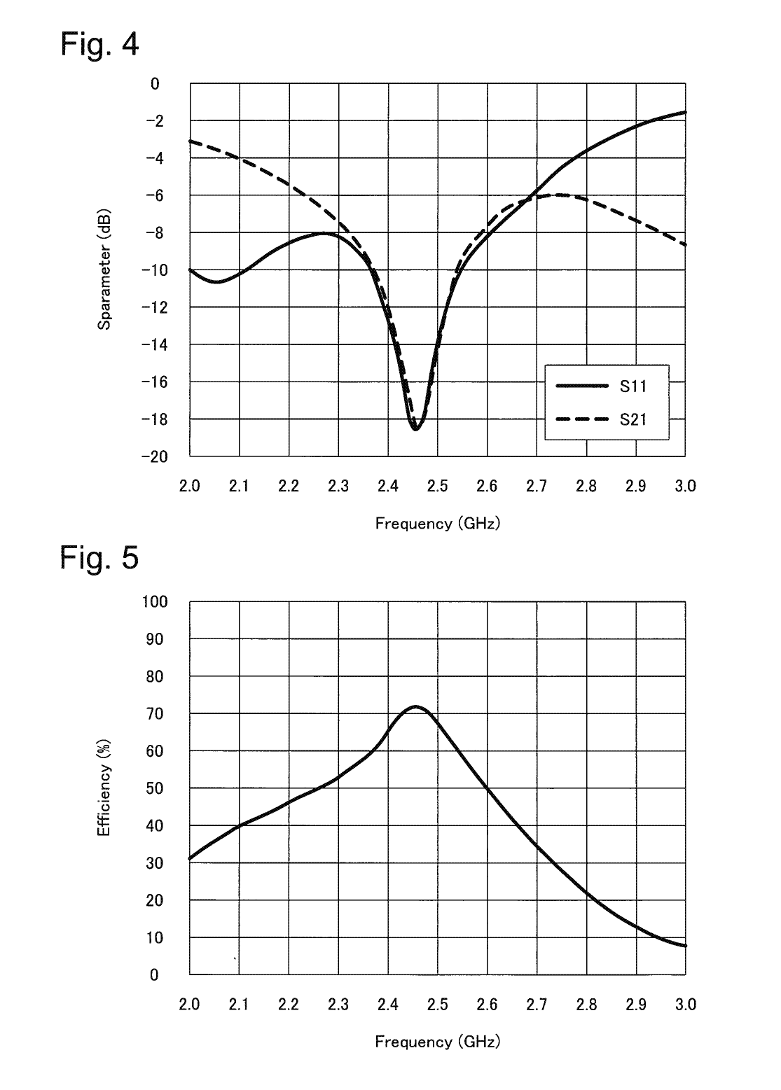

FIG. 4 is a graph representing frequency characteristics of S parameters of the MIMO antenna device 1 of the present exemplary embodiment. Since the MIMO antenna device 1 is structurally symmetrical when viewed from two feeding points, S11=S22 and S12=S21 hold. Thus, FIG. 4 illustrates only the results of S11 and S21 to simplify the graph.

It is assumed that a dimension of each portion of the MIMO antenna device 1 is that the width of the conductor layer 2: L1=106.7 mm, the depth of the conductor layer 2: L2=58.1 mm, the thickness of the conductor layer 2: L3=1 mm, the width of the opening portion 4: L4=28.9 mm, and the depth of the opening portion 4: L5=5 mm. It is also assumed that lumped constants of the matching circuits are X1=X3=3 pF and X2=X4=1.5 pF. The antennas are designed such that the operating band becomes a 2.4 to 2.5 GHz range. Referring to FIG. 4, both of S11 and S21 are equal to or less than −12 dB in 2.4 to 2.5 GHz. FIG. 4 shows that the MIMO antenna device 1 resonates and that isolation between antenna ports is realized.

FIG. 5 is a graph representing a frequency characteristic of an emission efficiency of the MIMO antenna device 1 of the present exemplary embodiment. Referring to FIG. 5, it can be seen that the emission efficiency is approximately 70% in 2.4 to 2.5 GHz and that the MIMO antenna device 1 is sufficiently operating as an antenna.

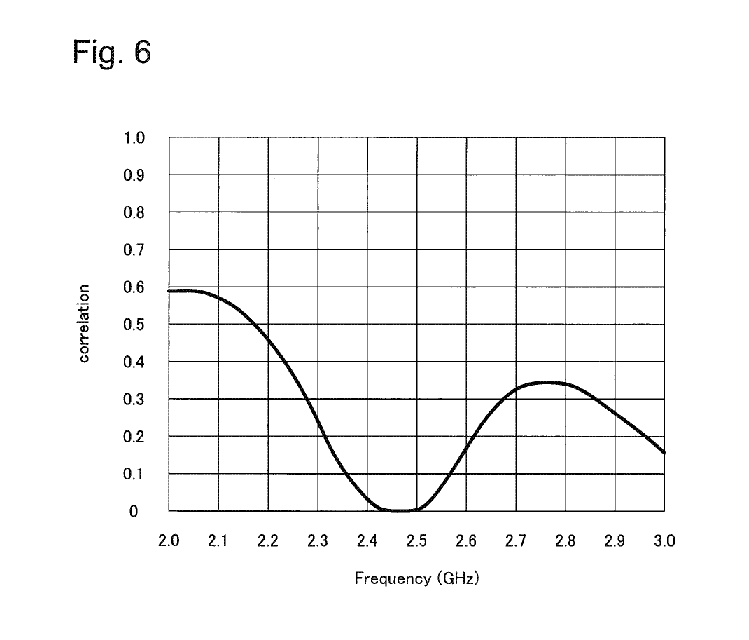

FIG. 6 is a graph representing a frequency characteristic of a correlation coefficient of the MIMO antenna device 1 of the present exemplary embodiment. The correlation coefficient is one of indicators in MIMO communication. The correlation coefficient represents a degree of correlation between signals which are respectively received by two feeding ports. The MIMO communication performance becomes better as the correlation coefficient is lower. The correlation coefficient is calculated according to the following Equation (1) by using the S parameters of FIG. 4.

$${ρ}_{e} = \frac{{\vert {S}_{11}^{*} {S}_{12} + {S}_{21}^{*} {S}_{22} \vert}^{2}}{( 1 - ( {\vert {S}_{11} \vert}^{2} + {\vert {S}_{21} \vert}^{2} ) ) ( 1 - ( {\vert {S}_{22} \vert}^{2} + {\vert {S}_{12} \vert}^{2} ) )} \qquad ( 1 )$$

According to FIG. 6, the correlation coefficient is approximately zero in the range of 2.4 to 2.5 GHz. In other words, this is an ideal characteristic in the MIMO communication.

According to the MIMO antenna device 1 of the present exemplary embodiment, a MIMO antenna device can be provided which is small in size and secures isolation between antenna ports by using the dual-split ring 3.

In the present exemplary embodiment, the MIMO antenna device 1 is configured as a three-layered structure of the first conductor layer 2a/the dielectric layer 10/the second conductor layer 2b. But it is possible to be configured as a single layer of a conductor layer or to be configured as a multi-layered structure such as a conductor layer/a dielectric layer/a conductor layer/a dielectric layer/a conductor layer. The multi-layered structure is realized by electrically connecting each conductor layer through a plurality of metal vias 8. Since a split portion is formed in each conductor layer, a number of split portions can be increased by multi-layering. By increasing a number of split portions, a capacitance value of the MIMO antenna device 1 can be increased. As the capacitance value becomes large, an inductance value required for obtaining a desired antenna resonant frequency can be reduced. In other words, a path length of the opening edge 5 which determines the value of the inductance can be shortened. This means that it is possible to be small the size of the dual-split ring 3. In other words, multi-layering of the MIMO antenna device 1 contributes to miniaturization of the antennas.

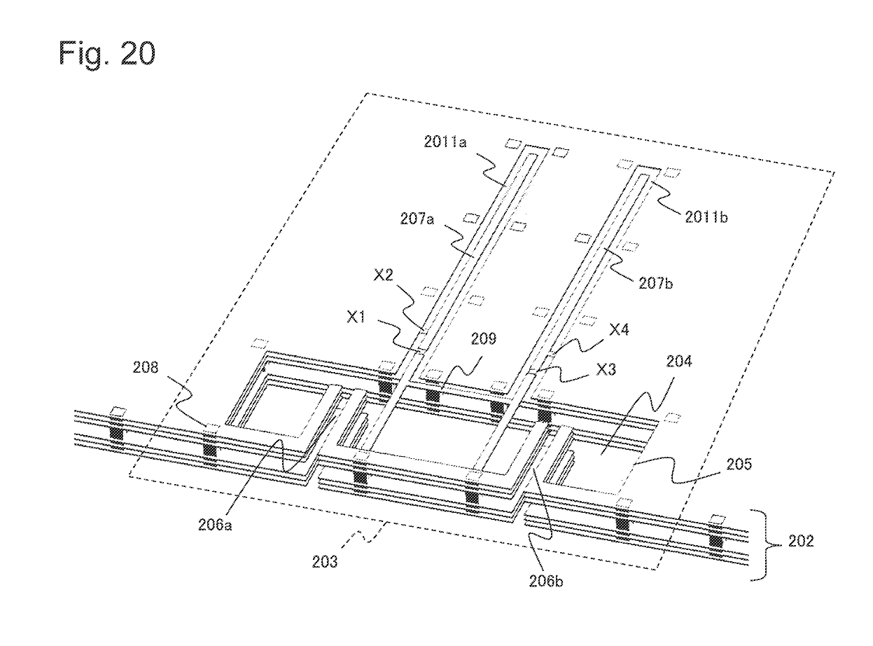

FIG. 20 is a perspective view illustrating a structure of a dual-split ring of a MIMO antenna device of the present exemplary embodiment in a case that a conductor layer is assumed to be six layers. A conductor layer 202 with six layers is electrically connected through a plurality of metal vias 208. A dielectric layer (omitted in FIG. 20) is sandwiched between each conductor layer 202. The uppermost layer of the conductor layer 202 is, similarly to FIG. 3, provided with a feed line 207a and a feed line 207b. The feed line 207a and the feed line 207b are provided along a clearance 2011a and a clearance 2011b in the conductor layer 202. L-shaped matching circuits are connected to the feed line 207a and the feed line 207b and formed using the lumped constants X1 to X4 in the conductor layer 202. A bridge line 209 connects between the feed line 207a and the feed line 207b in the conductor layer 202. The feed line 207a and the feed line 207b cross an opening portion 204 and include connection points with an opening edge 205 of the opening portion 204. Power is fed to the conductor layer 202 from the feed line 207a and the feed line 207b at these connection points.

Each layer of the conductor layer 202 with six layers includes a split portion 206a and a split portion 206b. By the split portion 206a and the split portion 206b being stacked in six layers, the MIMO antenna device with six-layered the split portion 206a and the split portion 206b can obtain a capacitance value larger than the MIMO antenna device with single layered the split portion 206a and the split portion 206b. In other words, the MIMO antenna device is miniaturized since a path length of the opening edge 205 can be shortened.

In the present exemplary embodiment, a number of split portions formed in the first conductor layer 2a is assumed to be two from the first split portion 6a and the second split portion 6b. However, a number of split portions of each layer may be more than two. But, since increasing a number of split portions results in increasing a serial capacitance component, it does not result in increasing an entire capacitance of the antenna. In other words, from a viewpoint of miniaturization of antennas, it brings about an adverse effect. Furthermore, a number of split portions of each layer may be one. However, when a number of split portions of each layer is one, the operation as an antenna becomes unstable. Therefore, two split portions in each layer are suitable.

In the MIMO antenna device of the present exemplary embodiment, 2×2 MIMO communication is assumed. However, for example, by arranging four of the present MIMO antenna devices in a printed circuit board, the MIMO antenna device easily realizes 8×8 MIMO communication.

As described above, according to the present exemplary embodiment, the MIMO antenna device 1 which is small in size and securing isolation between antenna ports is realized.

### Third Exemplary Embodiment

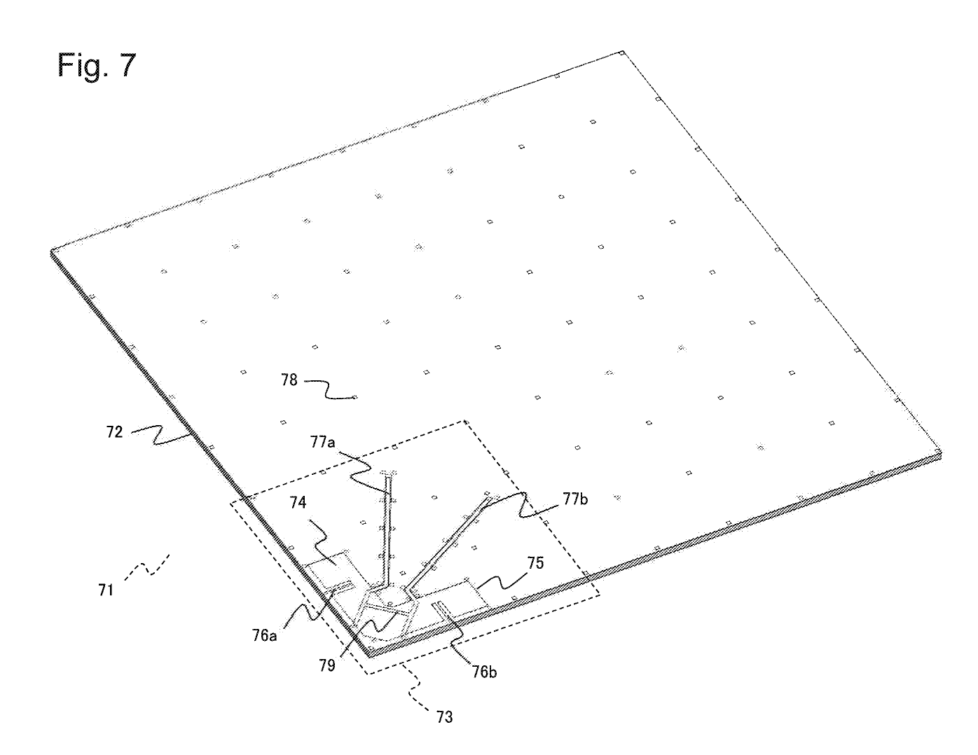

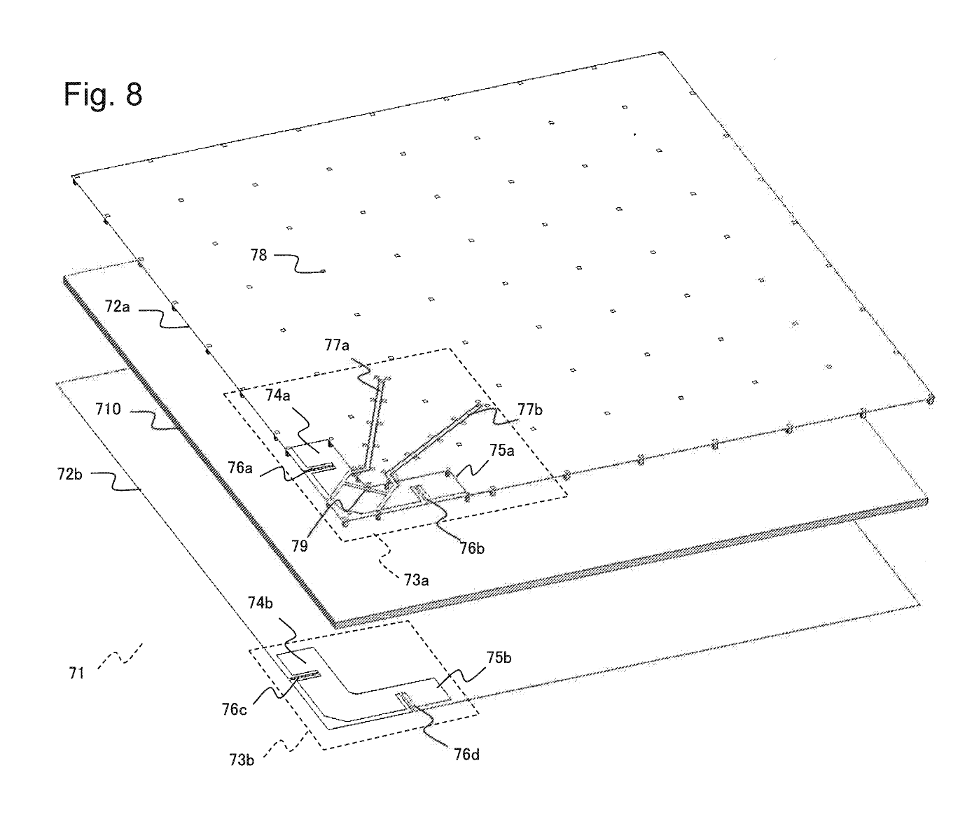

FIG. 7 is a perspective view illustrating a structure of a MIMO antenna device 71 of a third exemplary embodiment of the present invention. FIG. 8 is an exploded view illustrating the structure of the MIMO antenna device 71 of the third exemplary embodiment of the present invention.

The MIMO antenna device 71 of the present exemplary embodiment includes a conductor layer 72 having a first conductor layer 72a and a second conductor layer 72b on the front side and back side of a dielectric layer 710. The MIMO antenna device 71 includes a plurality of metal vias 8 for electrically connecting the first conductor layer 72a and the second conductor layer 72b through the dielectric layer 710. The first conductor layer 72a includes a first dual-split ring 73a. The first dual-split ring 73a includes a first opening portion 74a. A first opening edge 75a of the first opening portion 74a includes a first split portion 76a and a second split portion 76b which are cut up to a conductor edge which is an outer periphery of the first conductor layer 72a. Similarly, the second conductor layer 72b includes a second dual-split ring 73b. The second dual-split ring 73b includes a second opening portion 74b. A second opening edge 75b of the second opening portion 74b includes a third split portion 76c and a fourth split portion 76d which are cut up to a conductor edge which is an outer periphery of the second conductor layer 72b.

The dual-split ring 73 of the present exemplary embodiment is formed in a corner common to the first conductor layer 72a and the second conductor layer 72b unlike the dual-split ring 3 of the second exemplary embodiment. In each of the first conductor layer 72a and the second conductor layer 72b, an opening portion 74 of the dual-split ring 73 is formed in a right angle shape along the shape of the corner.

In addition, in the front side of the first conductor layer 72a, ends of a first feed line 77a and a second feed line 77b which are arranged across the first opening portion 74a are respectively connected to the first opening edge 75a. Two clearances (not illustrated in FIG. 7 and FIG. 8, refer to FIG. 3) are formed from the first opening portion 74a toward the inside of the first conductor layer 72a. The first feed line 77a and the second feed line 77b are respectively wired along the clearances. Power is fed to the first conductor layer 72a and the second conductor layer 72b from the first feed line 77a and the second feed line 77b.

Inside the first opening portion 74a of the first dual-split ring 73a, a bridge line 79 which bridges between the first feed line 77a and the second feed line 77b is arranged. When the first feed line 77a or the second feed line 77b feeds power, the bridge line 79 suppresses a current from being mixed into the other feed line. The MIMO antenna device 71 can secure isolation between antenna ports of the bridge line 79.

L-shaped matching circuits which are formed using lumped constants are connected to the first feed line 77a and the second feed line 77b in order to achieve matching with an input impedance of the dual-split ring 73 viewed from each of them (not illustrated in FIG. 7 and FIG. 8, refer to FIG. 3).

A resonant frequency of the antenna is determined by a capacitance arisen from the first split portion 76a and the second split portion 76b and the third split portion 76c and the fourth split portion 76d and an inductance arisen from path lengths of the first opening edge 75a and the second opening edge 75b. The resonant frequency becomes lower as magnitudes of the capacitance and the inductance become larger. Accordingly, a capacitance value can be increased by increasing lengths of the first split portion 76a and the second split portion 76b and the third split portion 76c and the fourth split portion 76d. This means that an antenna can be miniaturized without changing an occupied area of the entire antenna.

Furthermore, the dual-split ring 73 plays a role of two antennas by itself. Since the dual-split ring 73 does not need to space the two antennas apart with a certain interval unlike the MIMO antenna of PTL 1, it facilitates miniaturization of the entire MIMO antenna device 1.

As described above, according to the present exemplary embodiment, the MIMO antenna device 71 which is small in size and capable of securing isolation between antenna ports is realized.

### Fourth Exemplary Embodiment

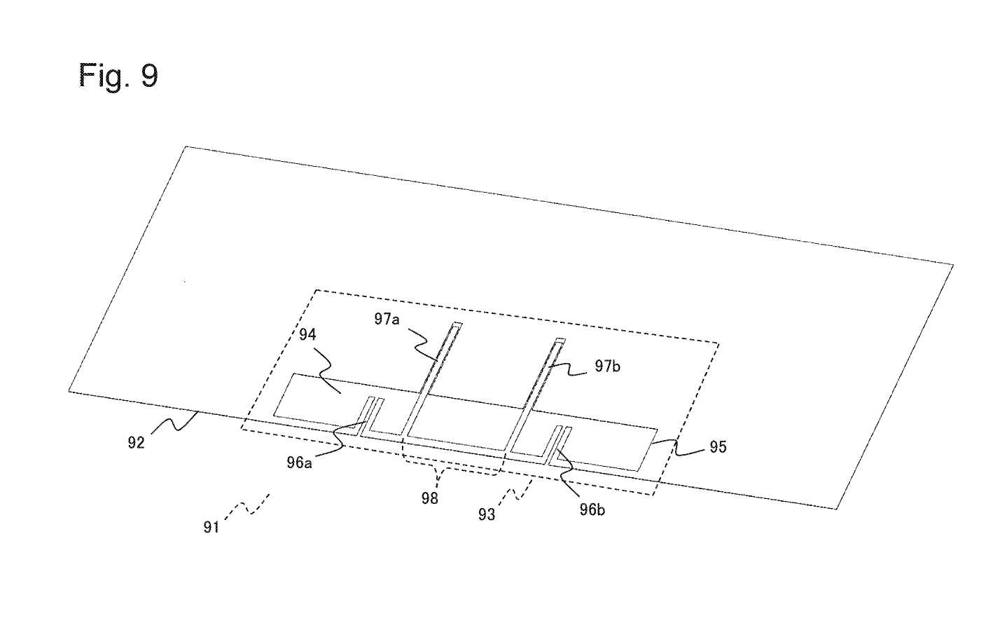

FIG. 9 is a perspective view illustrating a structure of a MIMO antenna device 91 of a fourth exemplary embodiment of the present invention.

A difference between the MIMO antenna device 91 of the fourth exemplary embodiment and the MIMO antenna device 1 of the second exemplary embodiment is that the MIMO antenna device 91 of the fourth exemplary embodiment is not provided with the bridge line 9 of the MIMO antenna device 1 (FIG. 3) of the second exemplary embodiment. Other configurations are the same as the MIMO antenna device 1 of the second exemplary embodiment.

An opening side 98 of the MIMO antenna device 91 has an effect that it also serves as the bridge line 9 of the MIMO antenna device 1 of the second exemplary embodiment. Therefore, the MIMO antenna device 91 can secure isolation between antenna ports without providing a bridge line. However, since the effect of the opening side 98 is inferior to the effect of the bridge line, isolation between antenna ports of the present exemplary embodiment is inferior to the second exemplary embodiment.

As described above, according to the present exemplary embodiment, the MIMO antenna device 91 which is small in size and capable of securing isolation between antenna ports is realized.

### Fifth Exemplary Embodiment

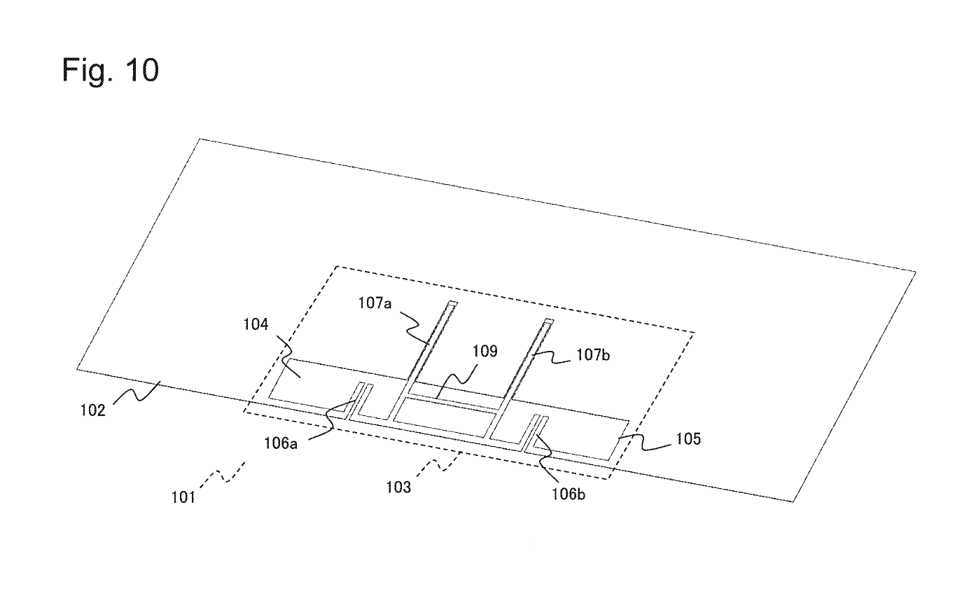

FIG. 10 is a perspective view illustrating a structure of a MIMO antenna device 101 of a fifth exemplary embodiment of the present invention.

A difference between the MIMO antenna device 101 of the fifth exemplary embodiment and the MIMO antenna device 1 of the second exemplary embodiment is that, in the MIMO antenna device 101 of the fifth exemplary embodiment, the bridge line 9 of the MIMO antenna device 1 (refer to FIG. 3) of the second exemplary embodiment is provided as a bridge line 109 in a position away from the opening edge 105. Other configurations are the same as the MIMO antenna device 1 of the second exemplary embodiment. Characteristics of the MIMO antenna device 101 of the fifth exemplary embodiment are equivalent to the MIMO antenna device 1 of the second exemplary embodiment.

As described above, according to the present exemplary embodiment, the MIMO antenna device 101 which is small in size and of securing isolation between antenna ports is realized.

### Sixth Exemplary Embodiment

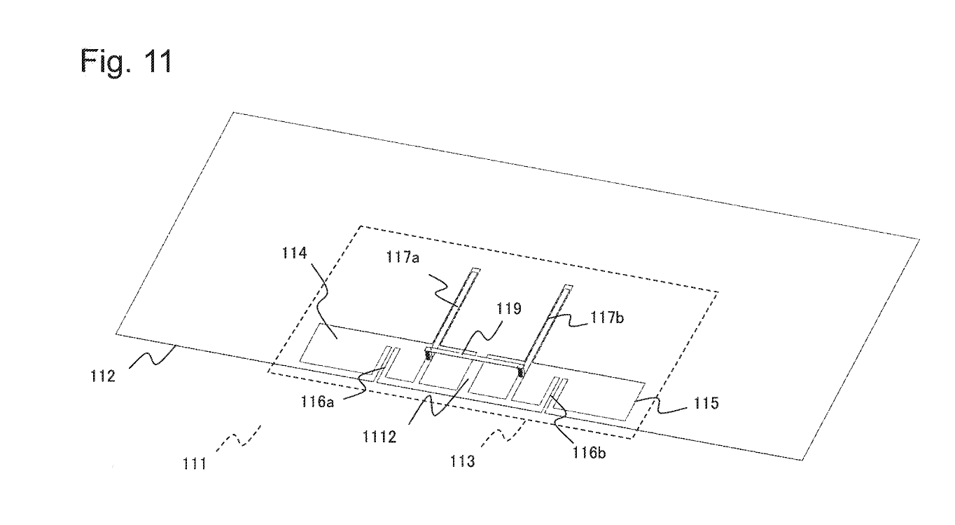

FIG. 11 is a perspective view illustrating a structure of a MIMO antenna device 111 of a sixth exemplary embodiment of the present invention.

A difference between the MIMO antenna device 111 of the sixth exemplary embodiment and the MIMO antenna device 1 of the second exemplary embodiment is that, in the MIMO antenna device 111 of the sixth exemplary embodiment, a separation line 1112 is provided in between a feed line 117a and a feed line 117b. The separation line 1112 crosses an opening portion 114 of the dual-split ring 113. Both ends of the separation line 1112 are connected to an opening edge 115. The separation line 1112 separates the dual-split ring 113 into two single-split rings. In this case, the bridge line 119 connects the feed line 117a and the feed line 117b sterically crossing the separation line 1112 so as not to contact with the separation line 1112. Other configurations are the same as the MIMO antenna device 1 of the second exemplary embodiment.

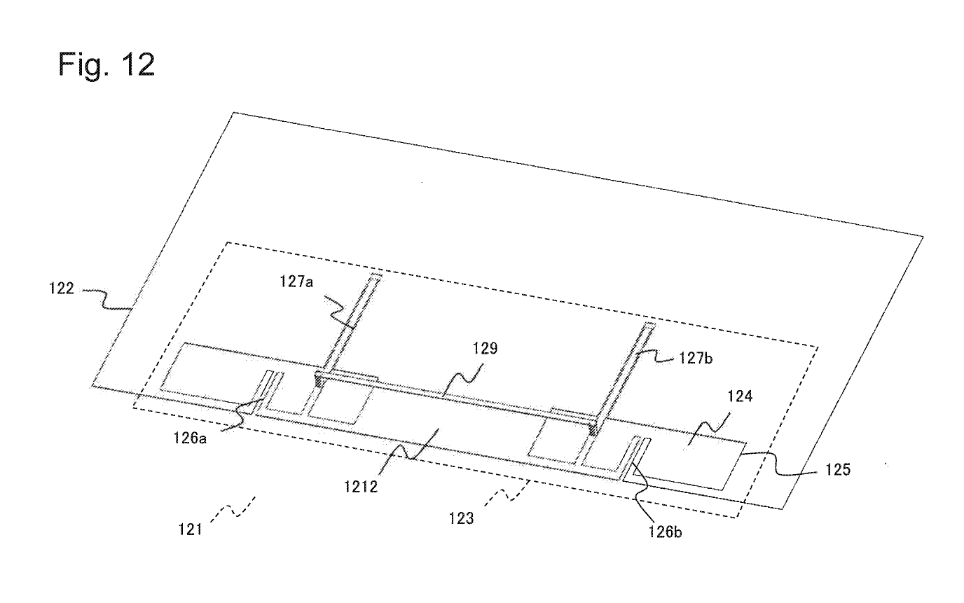

FIG. 12 is a perspective view illustrating, as a modified example of the MIMO antenna device 111 of the present embodiment, a structure of a MIMO antenna device 121 with the separation line 1112 being thickened. As illustrated in FIG. 12, a separation line 1212 can be thickened in the MIMO antenna device 121.

Almost no current flows in the separation line 1112 of FIG. 11 since its width is narrow. Accordingly, characteristics as an antenna are equivalent to the second exemplary embodiment regardless of the presence or absence of the separation line 1112. On the other hand, a certain amount of current flows in the separation line 1212 of FIG. 12 since its width is thick. Accordingly, characteristics equivalent to the structure of FIG. 11 can be obtained by adjusting the inductance by means of adjusting a path length of the opening edge 125.

As described above, according to the present exemplary embodiment, the MIMO antenna device 111 or 121 which is small in size and securing isolation between antenna ports is realized.

### Seventh Exemplary Embodiment

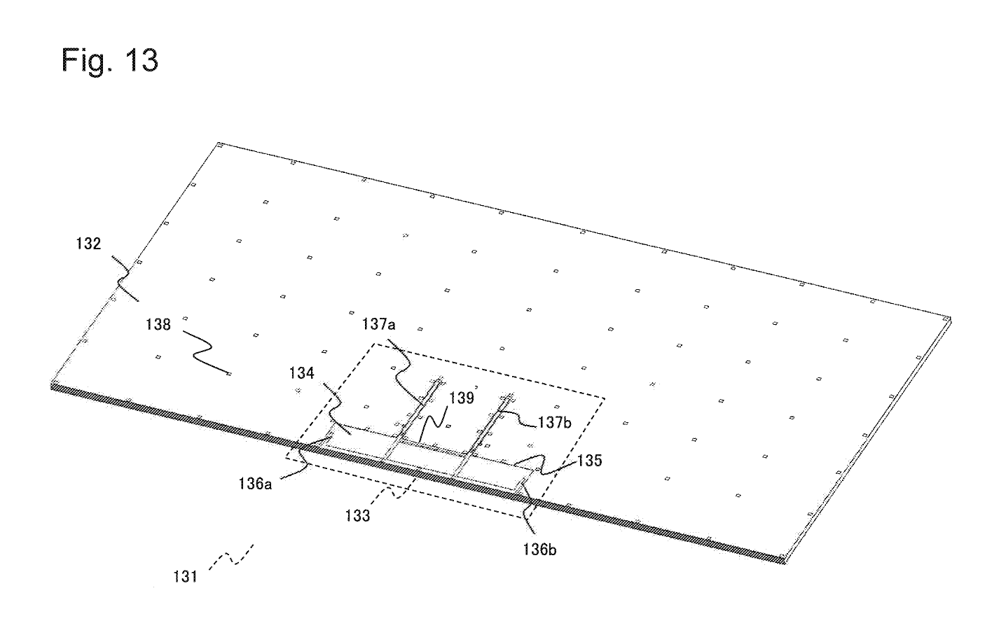

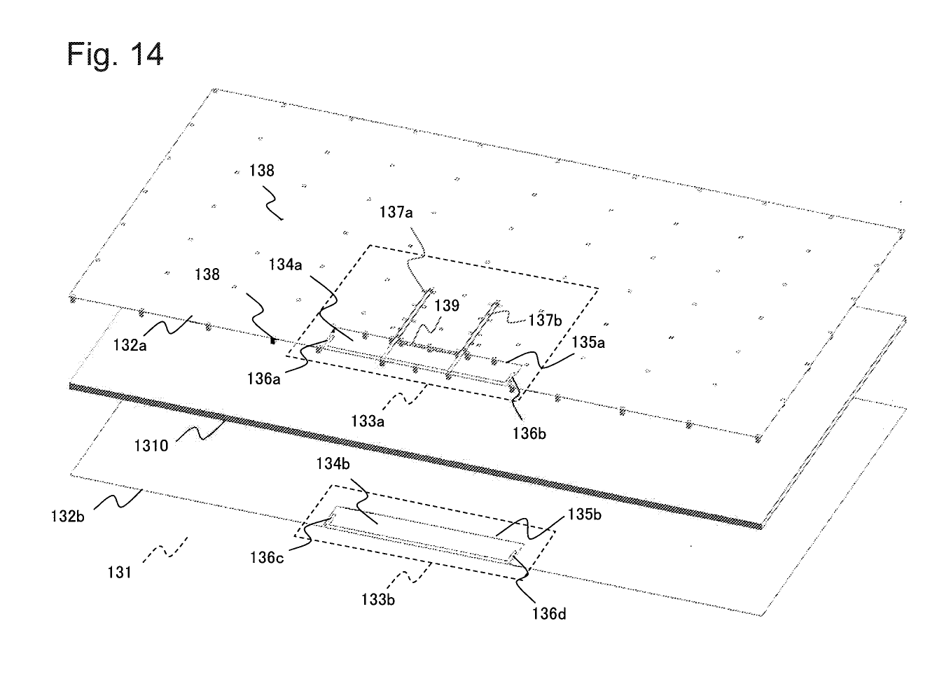

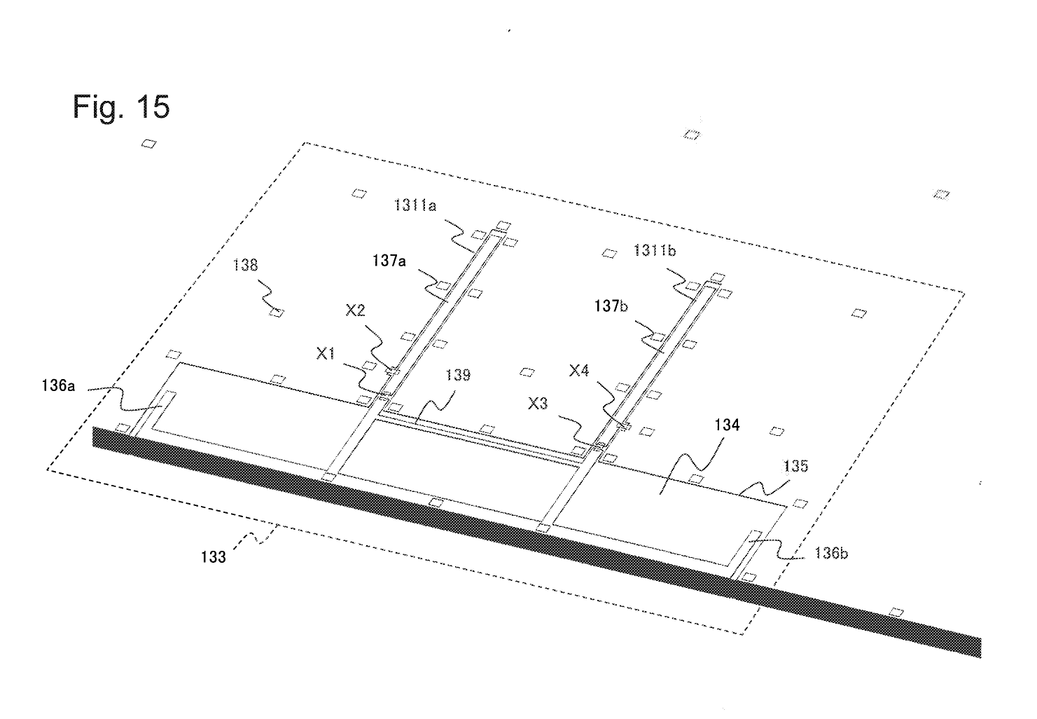

FIG. 13, FIG. 14, and FIG. 15 are perspective views of a MIMO antenna device 131 of a seventh exemplary embodiment of the present invention. FIG. 13 is a perspective view of the entire MIMO antenna device 131 of the present exemplary embodiment. FIG. 14 is an exploded view of the MIMO antenna device 131 of the present exemplary embodiment. FIG. 15 is an enlarged perspective view of a dual-split ring of the MIMO antenna device 131 of the present exemplary embodiment.

Differences between the MIMO antenna device 131 of the seventh exemplary embodiment and the MIMO antenna device 1 of the second exemplary embodiment are as follows. The MIMO antenna device 131 of the seventh exemplary embodiment includes a first opening portion 134a in a first conductor layer 132a. The first opening portion 134a includes a first opening edge 135a. The first opening edge 135a includes a first split portion 136a and a second split portion 136b. The first split portion 136a and the second split portion 136b are respectively at the ends of the first opening portion 134a. Similarly, the MIMO antenna device 131 includes a second opening portion 134b in a second conductor layer 132b. The second opening portion 134b includes a second opening edge 135b. The second opening edge 135b includes a third split portion 136c and a fourth split portion 136d. The third split portion 136c and the fourth split portion 136d are respectively at the ends of the second opening portion 134b. The opening edge 135a and the first split portion 136a and the second split portion 136b form pairs. The opening edge 135b and the third split portion 136c and the fourth split portion 136d form pairs. The MIMO antenna device 131 includes a first dual-split ring 133a and a second dual-split ring 133b which form a capacitance due to this structure.

The MIMO antenna device 131 of the seventh exemplary embodiment can obtain a radiation pattern different from the MIMO antenna device 1 of the second exemplary embodiment by providing the split portions at both ends of the opening portions.

As described above, according to the present exemplary embodiment, the MIMO antenna device 131 which is small in size and securing isolation between antenna ports is realized.

### Eighth Exemplary Embodiment

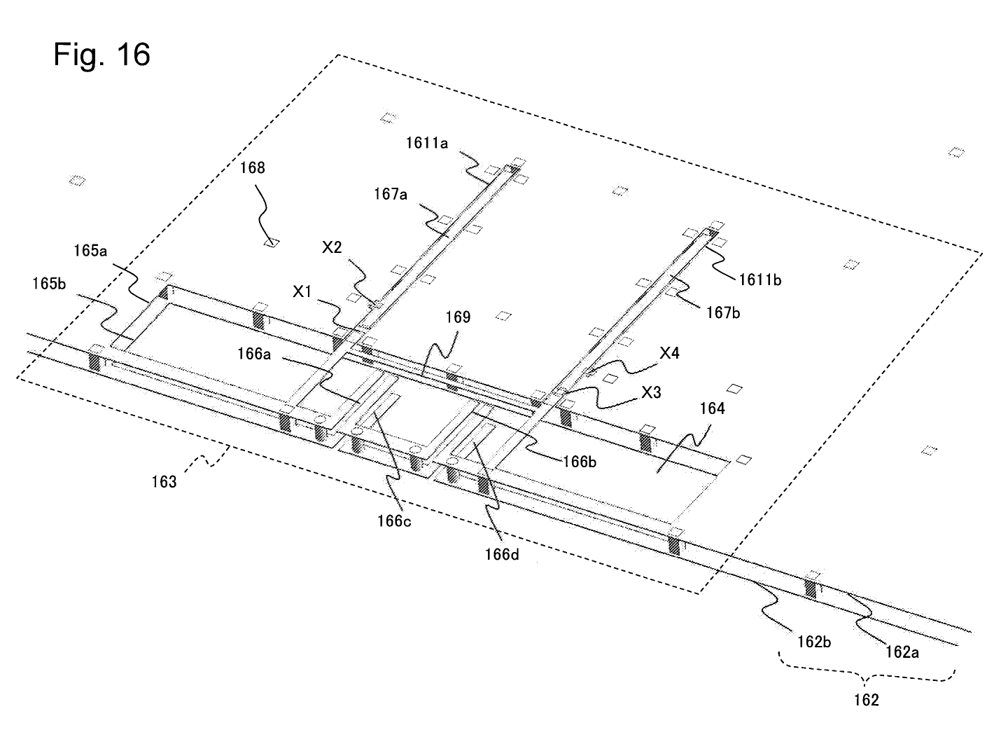

FIG. 16 is a perspective view illustrating a structure of a dual-split ring 163 of a MIMO antenna device of an eighth exemplary embodiment of the present invention.

A differences between the MIMO antenna device of the eighth exemplary embodiment and the MIMO antenna device 1 of the second exemplary embodiment is that, in the MIMO antenna device of the eighth exemplary embodiment, split portions 166a and 166b and split portions 166c and 166d are respectively arranged in an opening edge 165a and an opening edge 165b of a region sandwiched by a first feed line 167a and a second feed line 167b. Other configurations are the same as the MIMO antenna device 1 of the second exemplary embodiment. Characteristics of the MIMO antenna device of the present exemplary embodiment are equivalent to the MIMO antenna device 1 of the second exemplary embodiment.

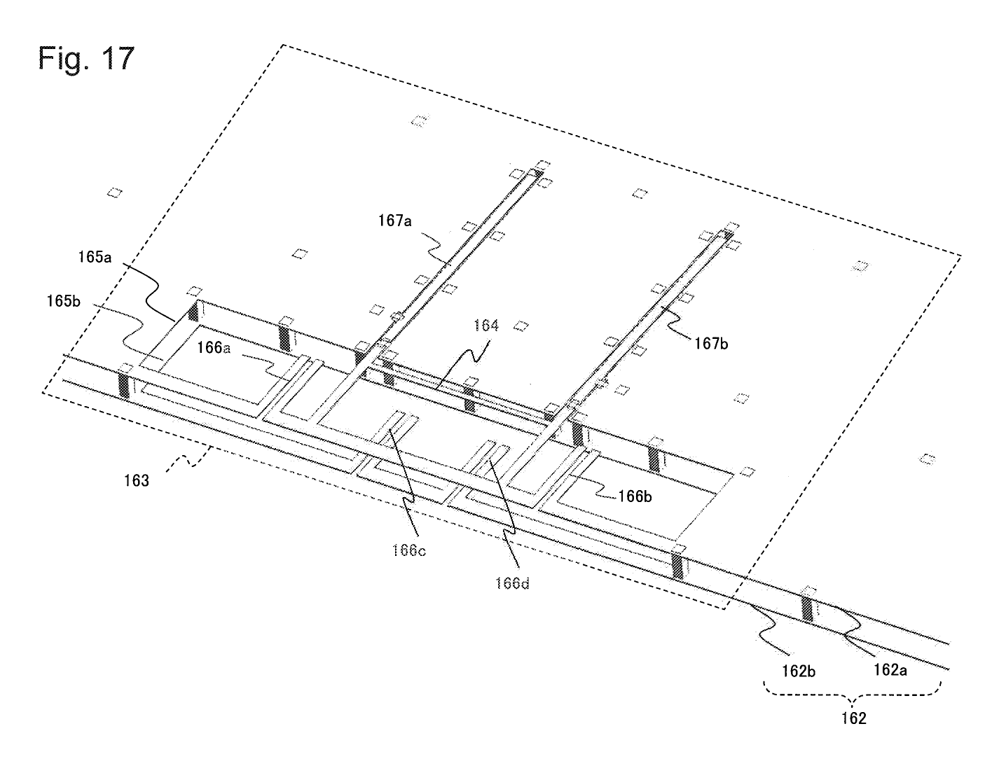

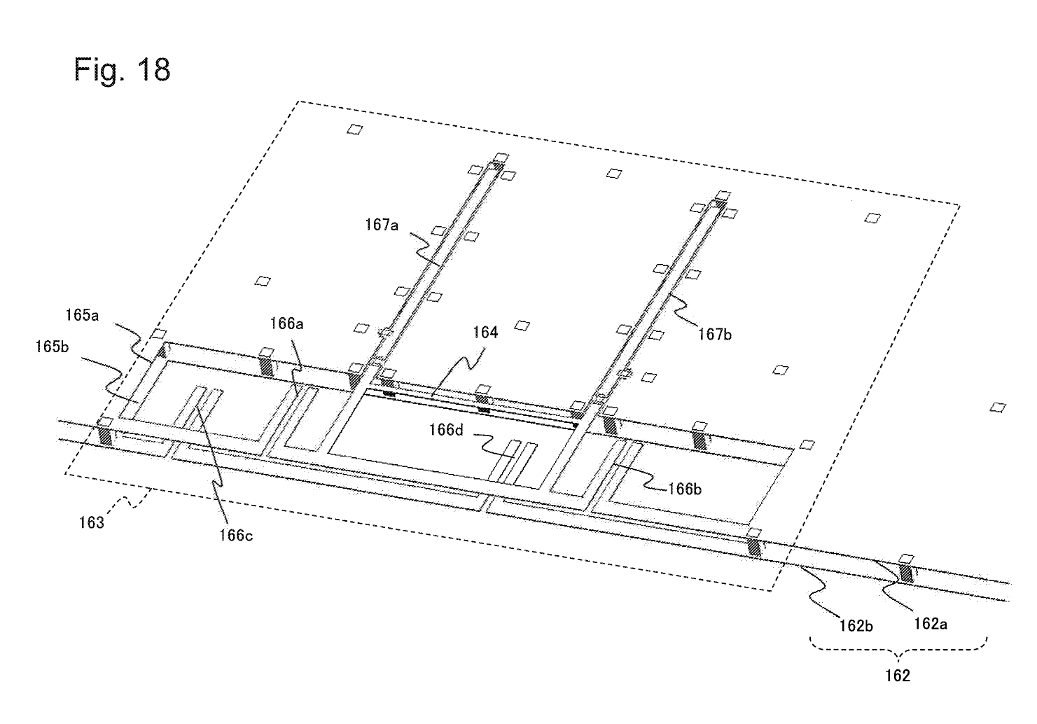

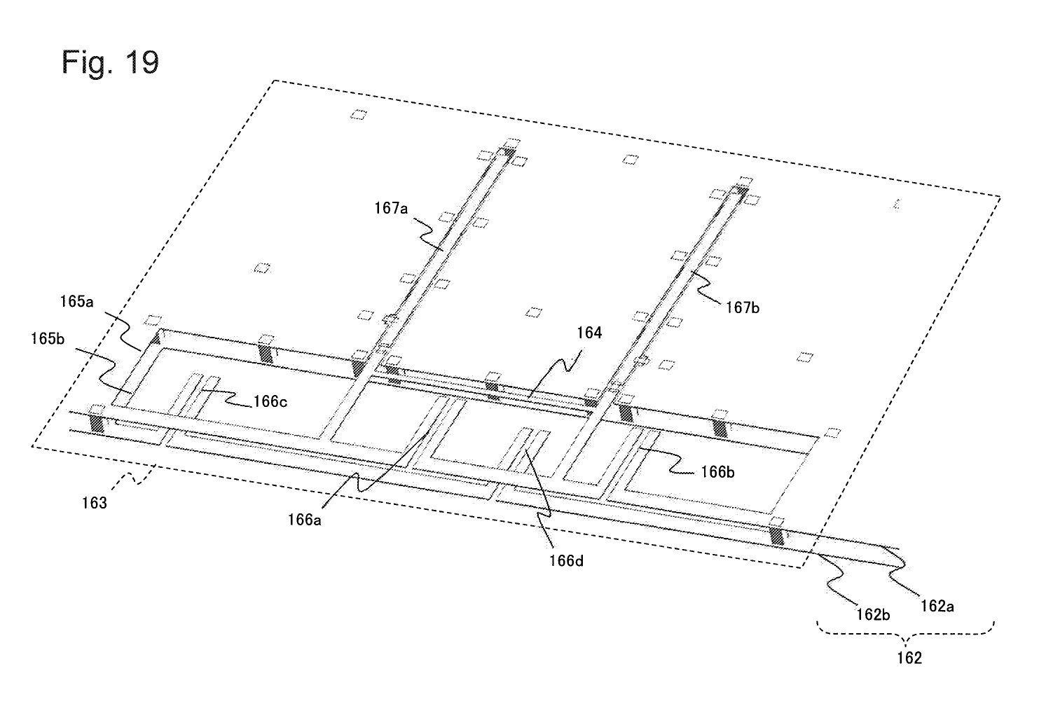

As modified examples of the eighth exemplary embodiment, structures illustrated, for example, in FIG. 17, FIG. 18, and FIG. 19 are possible. In other words, a conductor layer 162 is formed by a first conductor layer 162a and a second conductor layer 162b via a dielectric layer. In this structure, two positions of split portions 166a and 166b of the first conductor layer 162a and two positions of split portions 166c and 166d of the second conductor layer 162b can be, respectively, independently, and arbitrarily, set at an opening edge 165a and an opening edge 165b.

The two positions of the split portions 166a and 166b of the first conductor layer 162a are preferably not located in one side of the opening edge 165a which is outside of a region sandwiched by the first feed line 167a and the second feed line 167b as the structures illustrated in FIG. 17, FIG. 18, and FIG. 19. Similarly, the two positions of the split portions 166c and 166d are not located in one side of the opening edge 165b which is outside of a region sandwiched by the first feed line 167a and the second feed line 167b.

When each split portion 166 is independently provided as illustrated in FIG. 17, FIG. 18, and FIG. 19, a metal via 168 is not preferably installed in an opening side having the split portion 166 of the opening edge 165a of the first conductor layer 162a and the opening edge 165b of the second conductor layer 162b.

As described above, according to the present exemplary embodiment, the MIMO antenna device which is small in size and securing isolation between antenna ports is realized.

The present invention is not limited to the first to eighth exemplary embodiments described above and various modifications are possible within the scope of the invention described in the claims. In addition, modifications of the invention should be included in the scope of the present invention.

This application claims priority based on Japanese Patent Application No. 2013-111867, filed on May 28, 2013, the entire disclosure of which is incorporated herein.

### INDUSTRIAL APPLICABILITY

The present invention can be utilized as an antenna for a wireless communication device used in a MIMO system in wireless communication.

### REFERENCE SIGNS LIST

1, 11, 71, 91, 101, 111, 121, 131 MIMO antenna device
2, 13, 72, 92, 102, 112, 122, 132, 162, 202 Conductor layer
2a, 72a, 132a First conductor layer
2b, 72b, 132b Second conductor layer
3, 73, 93, 103, 113, 123, 133, 163, 203 Dual-split ring
3a, 73a, 93a, 103a, 113a, 123a, 133a First dual-split ring
3b, 73b, 93b, 103b, 113b, 123b, 133b Second dual-split ring
4, 74, 94, 104, 114, 124, 134, 164, 204 Opening portion
4a, 74a, 134a, 12 First opening portion
4b, 74b, 134b Second opening portion
5, 75, 95, 105, 115, 125, 135, 165, 205 Opening edge
5a, 75a, 135a, 14 First opening edge
5b, 75b, 135b Second opening edge
6a, 76a, 96a, 106a, 116a, 126a, 136a, 166a, 206a, 18a First split portion
6b, 76b, 96b, 106b, 116b, 126b, 136b, 166b, 206b, 18b Second split portion
6c, 76c, 136c Third split portion
6d, 76d, 136d Fourth split portion
7a, 77a, 97a, 107a, 117a, 127a, 137a, 167a, 207a, 16a First feed line
7b, 77b, 97b, 107b, 117b, 127b, 137b, 167b, 207b, 16b Second feed line
8, 78, 138, 168, 208 Metal via
9, 79, 109, 119, 129, 139, 169, 209 Bridge line
98 Opening side
10, 710, 1310 Dielectric layer
11a, 1311a, 1611a, 2011a First clearance
11b, 1311b, 1611b, 2011b Second clearance
1112, 1212 Separation line
15 Connection point
17 Conductor edge

1-10. (canceled)

11. A MIMO antenna device comprising:
a first conductor layer configured to have a first opening portion in the first conductor layer;
a first feed line and a second feed line respectively configured to be extended into the first opening portion from an edge of the first opening portion, and to feed power to the first conductor layer at the edge; and
a first split portion and a second split portion respectively configured to be arranged in the first conductor layer, and to connect an outside of the first conductor layer and the first opening portion.

12. The MIMO antenna device according to claim 11, wherein
the first split portion and the second split portion are configured to sandwich both of the first feed line and the second feed line.

13. The MIMO antenna device according to claim 11, wherein
at least one of the first split portion and the second split portion is configured to be sandwiched by the first feed line and the second feed line.

14. The MIMO antenna device according to claim 11, further comprising:
a bridge line configured to connect the first feed line and the second feed line.

15. The MIMO antenna device according to claim 11, further comprising:
a first clearance and a second clearance configured to be arranged in the first conductor layer, and to be extend into the first conductor layer from the edge of the first opening portion; wherein
the first feed line and the second feed line are respectively configured to be in the first clearance and the second clearance respectively.

16. The MIMO antenna device according to claim 14, further comprising:
a first separation line configured to separate the first opening portion into two separated first opening portions between the first split portion and the second split portion, and to be in non-contact with the bridge line.

17. The MIMO antenna device according to claim 11, wherein
at least one of the first feed line and the second feed line is configured to have at least one of impedance matching circuits.

18. The MIMO antenna device according to claim 17, wherein
the impedance matching circuits are configured to match an input impedances of the MIMO antenna device.

19. The MIMO antenna device according to claim 11, further comprising:
a second conductor layer configured to be laminated on the first conductor layer via a dielectric layer, to be electrically connected to the first conductor layer by a via, and to have a second opening portion in the second conductor layer; and
two split portions respectively configured to be arranged in the second conductor layer, and to connect an outside of the second conductor layer and the second opening portion.

20. The MIMO antenna device according to claim 19, further comprising:
a second separation line configured to separate the second opening portion into two separated second opening portions between the two split portions.

21. The MIMO antenna device according to claim 19, wherein
the second conductor layer is configured to be formed by a plurality of conductor layers laminated via a dielectric layer.

22. The MIMO antenna device according to claim 19, wherein
the two split portions are configured to sandwich both of the first feed line and the second feed line.

23. The MIMO antenna device according to claim 19, wherein
at least one of the two split portions is configured to be sandwiched by the first feed line and the second feed line.

24. The MIMO antenna device according to claim 12, further comprising:
a bridge line configured to connect the first feed line and the second feed line.

25. The MIMO antenna device according to claim 24, further comprising:
a first clearance and a second clearance configured to be arranged in the first conductor layer, and to be extend into the first conductor layer from the edge of the first opening portion; wherein
the first feed line and the second feed line are respectively configured to be in the first clearance and the second clearance respectively.

26. The MIMO antenna device according to claim 25, further comprising:
a first separation line configured to separate the first opening portion into two separated first opening portions between the first split portion and the second split portion, and to be in non-contact with the bridge line.

27. The MIMO antenna device according to claim 16, wherein
at least one of the first feed line and the second feed line is configured to have at least one of impedance matching circuits.

28. The MIMO antenna device according to claim 27, further comprising:
a second conductor layer configured to be laminated on the first conductor layer via a dielectric layer, to be electrically connected to the first conductor layer by a via, and to have a second opening portion in the second conductor layer; and
two split portions respectively configured to be arranged in the second conductor layer, and to connect an outside of the second conductor layer and the second opening portion.

29. The MIMO antenna device according to claim 28, wherein
the two split portions are configured to sandwich both of the first feed line and the second feed line.

30. The MIMO antenna device according to claim 28, wherein
the second conductor layer is configured to be formed by a plurality of conductor layers laminated via a dielectric layer.
